(19) United States
(12) Patent Application Publication
(10) Pub. No.: US 2008/0195886 A1
(43) Pub. Date: Aug. 14, 2008

(54) DISK CONTROLLER AND METHOD THEREOF

(75) Inventor: Eisaku Takahashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/021,733

(22) Filed: Jan. 29, 2008

(30) Foreign Application Priority Data
Feb. 9, 2007 (JP) 2007-30334

(51) Int. Cl. G06F 11/07

(52) U.S. Cl. 714/2; 714/E11.023

(57) ABSTRACT

A disk controller and method thereof having a configuration where when a disk apparatus fails, information on the failed disk apparatus is prevented from unauthorized access including a read operation. The disk controller in a disk system connected with a plurality of disk apparatuses includes a control information storage area overwrite unit issuing an instruction to overwrite a control information storage area of a disk apparatus with a predetermined value when a failure of the disk apparatus is detected.

### CROSS-REFERENCE TO RELATED APPLICATIONS

This application is related to and claims the benefit of priority from Japanese Patent Application No. 2007-30334, filed on Feb. 9, 2007, the entire contents of which are incorporated herein by reference.

### BACKGROUND

1. Field

The present invention relates to a disk controller and method thereof.

2. Description of the Related Art

In recent years, with initiatives such as the Act for Protection of Computer Processed Personal Data held by Administrative Organs put in force, countermeasures against leakage of customer information and unauthorized access of information are required. Thus, if even a disk apparatus, which has failed and which may be transported for repairs or the like with customer information stored therein, is lost or stolen and data can easily be read, this could lead to leakage of customer information, causing damage incomparable to the physical loss. Therefore, a failed disk apparatus must reliably be disabled so that data cannot be read.

If an error occurs in a disk apparatus mounted in a RAID system, according to a typical procedure, the failed disk apparatus is simply detached from the RAID system and then packed and shipped directly in its present existing condition. However, analysis of failed disk apparatuses shows that about half of failures were not reproducible and all data in the disk could be read by a normal operation. Data could still be read, though not all data, from the other half of failures mostly by a normal operation and failures that completely disabled reading of data accounted for only several percentage points of all failures.

Thus, when a disk apparatus is detached from a RAID system, data in the disk apparatus is typically deleted by a normal write function so that data in the disk apparatus to be detached cannot be read, however, a lot of time is required to delete an entire area of the disk apparatus. Moreover, the disk apparatus is determined to have failed and it cannot be guaranteed that a normal write operation for deletion is successfully performed. Therefore, it is necessary to transport the disk apparatus under tight security to ensure against unauthorized access of information or physically destroy the disk apparatus, leading to higher costs.

FIG. 6 shows a flow of processing of detaching a typical failed disk apparatus.

In operation S10 of the processing flow, a normal processing of RAID for detecting, for example, a failure of a disk apparatus is performed. In operation S11 of the processing flow, a failed disk apparatus is detected and it is determined whether or not the failed disk apparatus matches detachment conditions from the RAID system. If the failed disk apparatus does not match the detachment conditions in operation S11 the processing flow returns to operation S10 to perform processing for other disk apparatuses. If the failed disk apparatus matches the detachment conditions in operation S11, in operation S12 of the processing flow, data of the failed disk apparatus is transferred to a standby disk apparatus to restore redundancy. In operation S13 of the processing flow, processing to detach the failed disk apparatus from the RAID system is performed. Next, the processing flow returns to operation S10 to determine whether any other disk apparatus has failed or not.

The present invention provides a disk controller and method thereof having a configuration so that, when a disk apparatus fails, information on the failed disk apparatus is prevented from unauthorized access including unintended information read from the failed disk apparatus.

### SUMMARY

The disclosed disk controller of a disk system connected with a plurality of disk apparatuses includes a control information storage area overwrite unit issuing an instruction to overwrite a control information storage area of a disk apparatus with a predetermined value when a failure of the disk apparatus is detected.

Additional aspects and/or advantages will be set forth in part in the description which follows and, in part, will be apparent from the description, or may be learned by practice of the invention.

The disclosed disk controlling method includes detecting a failure of a disk apparatus, and issuing an instruction to overwrite a storage area of the disk apparatus with a predetermined value responsive to the detecting.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram illustrating a RAID system;

FIG. 2 is a block diagram illustrating a disk apparatus;

FIG. 3 is a processing flow of a RAID system;

FIG. 4 is a flowchart illustrating details of a processing in operation S18 of FIG. 3;

FIG. 5 is a flowchart illustrating a processing of a disk apparatus having received a head adsorption instruction; and

FIG. 6 is a flowchart of a typical processing of detaching a failed disk apparatus.

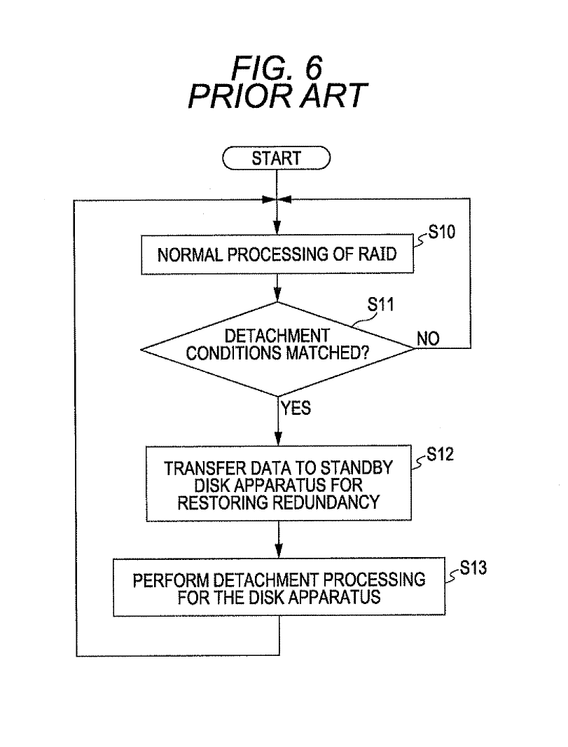

### DETAILED DESCRIPTION OF THE PREFERRED EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

A disk apparatus during activation reads a System Area (SA) of the disk apparatus, and then a user area becomes ready for normal data writing/reading. If the SA is not read successfully, data cannot be normally written to/read from the disk apparatus. In an embodiment of the present invention, inhibition of reading the user area is realized by overwriting the SA area with unspecified data when a failure is detected.

Depending on a failure mode of the disk apparatus, data cannot be written to the disk apparatus when some types of failures occur. In such cases, unspecified data cannot be written to the SA area. In this case, the head is caused to move to an outer position (for example, a periphery of a disk medium) and in this state, motors for disk medium rotation and head drive are stopped. Accordingly, the head is grounded to a surface of the medium at the outer position. The head and medium of the disk apparatus are in a state of mirror finished surface. Thus, if the head is grounded to any other place (i.e., outer position) than a place (CSS zone) with unevenness inside the disk apparatus for performing contact start/stop (CSS), the head is adsorbed onto the disk medium. If the head is adsorbed at the outer position, the rotation moment will be larger even if adsorption power is the same because the outer side is farther away from a rotation center of the motor. Therefore, by causing the head to be grounded at the outer position, it becomes more difficult for the adsorbed disk medium and head to separate, ensuring more reliable adsorption. Naturally, a failure of a servo control unit is also assumed and a control by which a voltage to cause the head to move to the outer position is applied to a voice coil motor (VCM) is performed without assuming the servo control. Accordingly, reading data from the disk apparatus can be prevented when various kinds of failure occur. If there occurs a failure in which the VCM simply cannot cause the head to move to the outer position, data cannot be read in this state and therefore, no problem is posed.

In an embodiment of the present invention, reading data from a disk apparatus can be inhibited in a short time by overwriting the SA area with unspecified data when a failure occurs. Even if a failure mode does not allow overwriting the SA area, the operation of the disk apparatus can reliably be inhibited in a short time by realizing adsorption of the head and medium at the outer position. However, if the head is caused to be adsorbed onto the medium, the head and medium cannot be reused for repairs, making adsorption disadvantageous in terms of costs. Therefore, both prevention of data leakage and cost-effective preventive measures in a short time can be realized by overwriting the SA area when a failure occurs and, if the SA area cannot be overwritten, by causing the head to be adsorbed onto the medium.

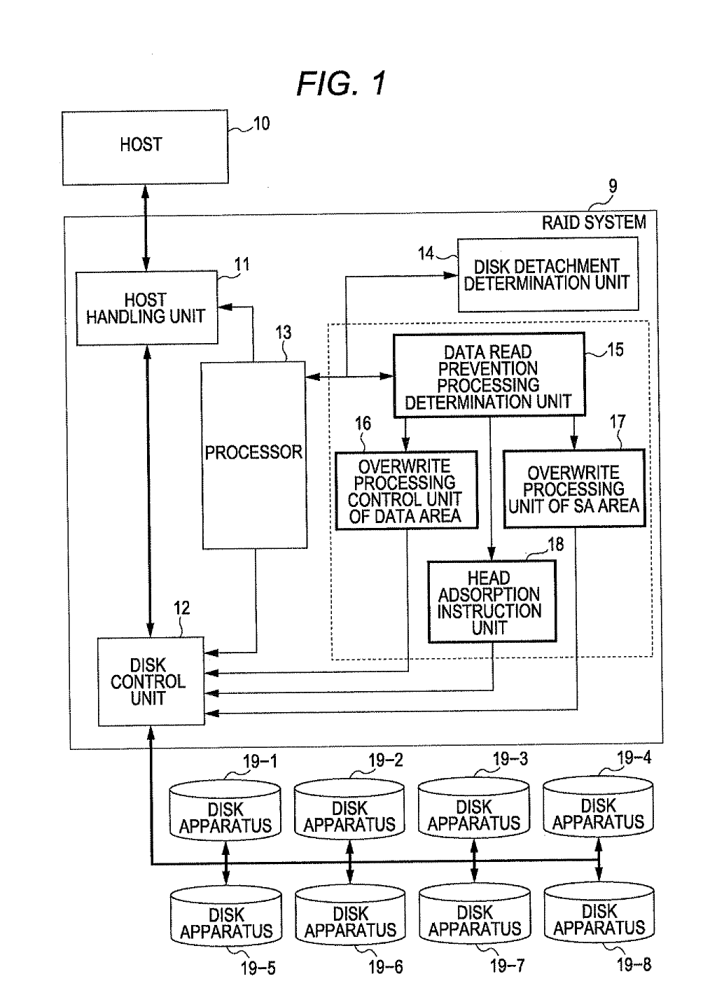

FIG. 1 is a block diagram of a RAID system according to an embodiment of the present invention.

As shown in FIG. 1, a host 10 is connected with a RAID system 9, and disk apparatuses 19-1 to 19-8 are connected with the RAID system 9. The host 10 accesses the disk apparatuses 19-1 to 19-8 via the RAID system 9. A host handling unit 11 is provided in the RAID system 9 to operate as an interface between the RAID system 9 and the host 10. Further, a disk control unit 12 operates as an interface between the RAID system 9 and the disk apparatuses 19-1 to 19-8. A processor 13 issues instructions to the host handling unit 11 and the disk control unit 12 to perform, for example, failure diagnosis processing pertaining to the disk apparatuses 19-1 to 19-8 and processing to notify the host 10 of a failure diagnosis result. When the processor 13 performs a failure diagnosis in relation to the disk apparatuses 19-1 to 19-8 and receives a result of the diagnosis, the failure diagnosis result is sent to a disk detachment determination unit 14. Upon receipt of the failure diagnosis result, the disk detachment determination unit 14 determines a disk apparatus that has failed and notifies the processor 13 of the disk apparatus to be detached.

Here, in an embodiment of the invention, further provided are a data read prevention processing determination unit 15, overwrite processing control unit of data area 16, overwrite processing unit of an SA area 17, and a head adsorption instruction unit 18. The data read prevention processing determination unit 15 obtains information about which disk apparatus to detach from the disk detachment determination unit 14 and, before detaching the disk apparatus, performs processing so that data inside the failed disk apparatus will not be read afterward. When performing the processing, the data read prevention processing determination unit 15 provides instruction(s) of the processing to the data area overwrite processing control unit 16, SA area overwrite processing unit 17, or head adsorption instruction unit 18 depending on the processing to be performed. The data area overwrite processing control unit 16 deletes data stored in a data area of a disk apparatus by overwriting the data area of the disk apparatus whose detachment has been determined with, for example, “0”. The SA area overwrite processing unit 17 invalidates control information of a disk apparatus by overwriting the SA area of the disk apparatus with data (for example, meaningless or arbitrary data) or “0”, making the disk apparatus inaccessible. The head adsorption instruction unit 18 performs a processing to cause the head of a failed disk apparatus to be adsorbed onto the outer area of a disk medium when it is determined that neither data area nor SA area can be overwritten.

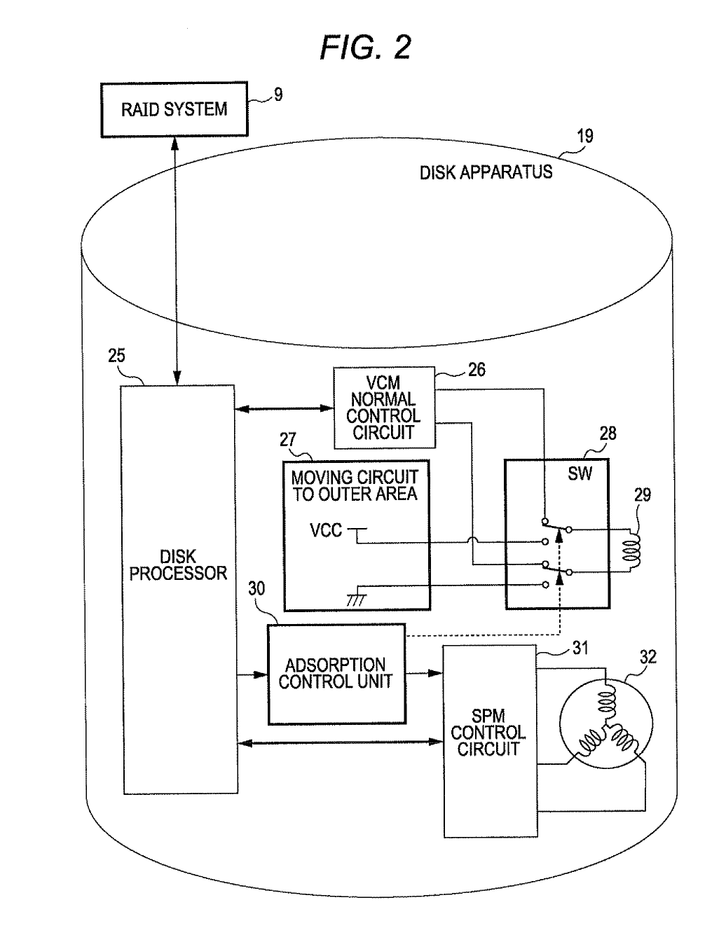

FIG. 2 is a block diagram of a disk apparatus according to an embodiment of the invention.

The disk apparatus 19 is provided with a disk processor 25, which interprets instruction(s) from the RAID system 9 and provides instruction(s) to each control circuit to perform predetermined processing. Upon receipt of instruction(s) from the disk processor 25, a VCM normal control circuit 26 generates a control voltage of a VCM 29. Movement of the head during normal operation is controlled by the control to the VCM 29. An SPM control circuit 31 generates a control voltage for controlling the operation of an SPM (spindle motor) 32. The SPM 32 controls rotation of a disk medium. When an instruction to overwrite a data area or overwrite the SA area is received from the RAID system 9, the SPM control circuit 31 rotates the SPM 32 and the VCM normal control circuit 26 controls the VCM 29 to move the head to cause overwriting. However, if a predetermined overwrite operation cannot be performed because the VCM normal control circuit 26 has failed or the like, the RAID system 9 is notified that the predetermined overwrite operation cannot be performed. Then, the RAID system 9 instructs the disk processor 25 to perform head adsorption. An adsorption control unit 30 is notified of this instruction and a switch 28 is changed to cause a fixed voltage from a moving circuit 27 to an outer area to be applied to the VCM 29. The fixed voltage of the moving circuit 27 to the outer position is a voltage necessary to move the head to the outer area, which is a periphery of a disk medium. The adsorption control unit 30 also instructs the SPM control circuit 31 to stop the SPM 32. Accordingly, the head is adsorbed onto the disk medium, making data unreadable.

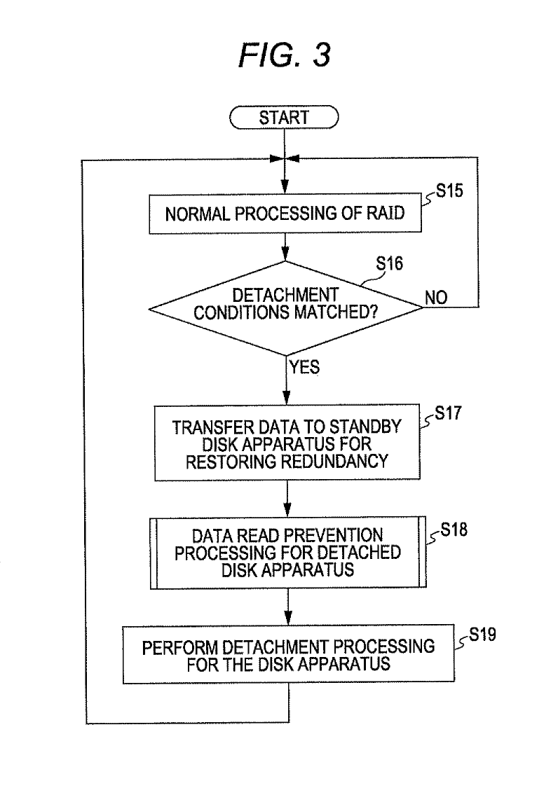

FIG. 3 is a processing flow of a RAID system according to an embodiment of the invention.

In operation S15, normal processing of RAID such as a failure inspection of disk apparatus(es) is performed. In operation S16, it is determined whether or not a disk apparatus being processed matches detachment condition(s) (for example, not writable, not readable and the like). When determining that the disk apparatus does not meet the detachment conditions in operation S16, processing of other disk apparatuses is performed after returning to operation S15. When determining in operation S16 that the detachment condition(s) is met, the same data as the data in the disk apparatus that meets the detachment condition(s) is transferred to a standby disk apparatus in operation S17 to restore redundancy. If, for example, a case in which mirror redundancy is performed as a redundant configuration is considered, disk apparatuses are generally grouped into pairs of two disk apparatuses and the two disk apparatuses store the same data. In a RAID system, in addition to such mirror disk apparatuses, a standby disk apparatus in which normally no data is stored is provided. If now a disk apparatus fails, data in the failed disk apparatus is also stored in the other paired disk apparatus because of mirror redundancy, and therefore, the data will not be lost. However, since one disk apparatus has failed, data stored in the disk apparatus is no longer mirror-redundant. Thus, the data is copied from the other normal disk apparatus paired with the failed disk apparatus to the standby disk apparatus provided in the RAID system, and the other normal disk apparatus and the standby disk apparatus are paired to maintain mirror redundancy of the data.

In operation S18, a data read prevention processing for the detached disk apparatus is performed and in operation S19, a detachment processing for the disk apparatus meeting the detachment conditions is performed before returning to operation S15.

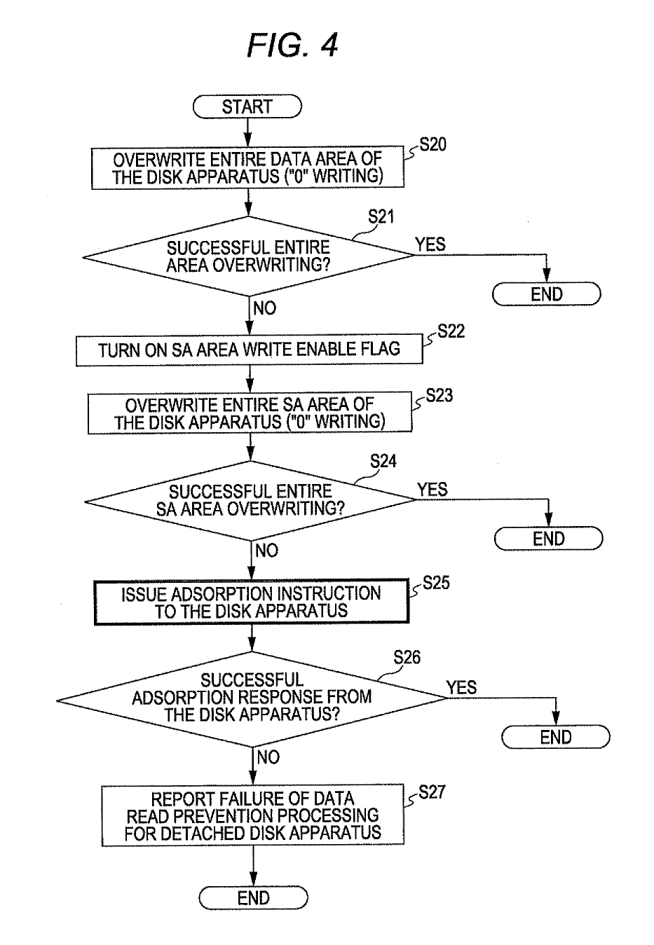

FIG. 4 is a flow showing details of a processing in operation S18 of FIG. 3.

In operation S20, an entire data area of the disk apparatus is overwritten with “0” (“0” writing). In operation S21, it is determined whether or not overwriting the entire data area has been successful. When the determination of operation S21 is Yes, processing is terminated. When the determination of operation S21 is No, a write enable flag of the SA area is turned on in operation S22 and an entire area of SA of the disk apparatus is overwritten with “0” in operation S23. In operation S24, it is determined whether or not overwriting the entire area of SA has been successful. If the determination of operation S24 is Yes, processing is terminated. When the determination of operation S24 is No, an adsorption instruction is issued to the relevant disk apparatus in operation S25. In operation S26, it is determined whether or not a response of successful execution of adsorption processing has been received from a relevant disk apparatus. If a response of successful execution is received in operation S26, processing is terminated. If no response of successful execution is received in operation S26, a failure of data read prevention processing for the detached disk apparatus is reported to the host in operation S27 before terminating processing.

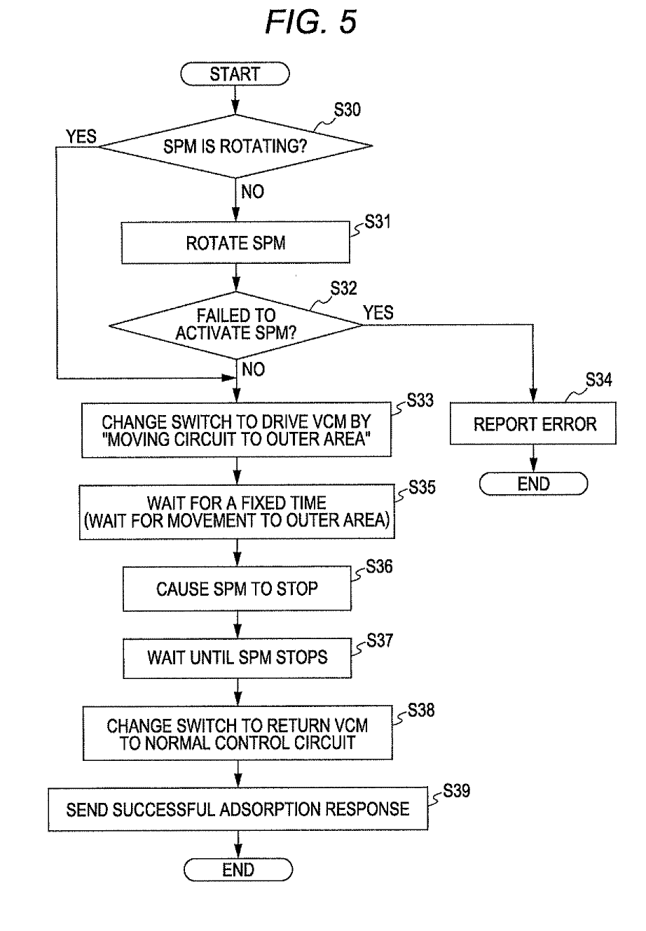

FIG. 5 is a flow showing a processing of a disk apparatus having received a head adsorption instruction.

In operation S30, whether or not the SPM is rotating is determined. If the determination of operation S30 is Yes, processing jumps to operation S33. If the determination of operation S30 is No, the SPM is caused to rotate in operation S31 and whether or not activation of the SPM is successful is determined in operation S32. If the determination of operation S32 is Yes, an error report is made to the RAID system in operation S34 before terminating processing. If the determination of operation S32 is No, a switch is changed in operation S33 to drive the VCM by the moving circuit to the outer area. In operation S35, movement of the head to the outer area is awaited (A waiting time of fixed time may be suitably set by a user). In operation S36, the SPM is caused to stop and in operation S37, stopping of the SPM is awaited. In operation S38, the switch is changed to return the VCM to the normal control circuit and in operation S39, a response of successful adsorption is sent to the RAID system before terminating processing.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A disk controller of a disk system connected with a plurality of disk apparatuses, comprising:
a control information storage area overwrite unit issuing an instruction to overwrite a control information storage area of a disk apparatus with a predetermined value when a failure of the disk apparatus is detected.

2. The disk controller according to claim 1, comprising:
a data area overwrite unit issuing an instruction to overwrite a data area of the disk apparatus with a predetermined value before overwriting the control information storage area of the disk apparatus in which the failure has been detected, and
wherein when the data area cannot be overwritten, the control information storage area is caused to be overwritten.

3. The disk controller according to claim 2, comprising:
an adsorption instruction unit issuing an instruction to cause a head of the disk apparatus in which the failure has been detected to be adsorbed onto a disk medium, and
wherein when both the data area and the control information storage area cannot be overwritten, the head of the disk is caused to be adsorbed onto the disk medium.

4. The disk controller according to claim 3, wherein the head is caused to be adsorbed onto an area outside a contact start/stop area of the disk medium.

5. A disk apparatus controlled by the disk controller according to claim 3, comprising:
a fixed voltage application unit applying a fixed voltage for causing the head to move to an adsorption position of the disk medium to a motor driving the head, and
wherein when an instruction to cause the head to be adsorbed onto the disk medium is received from the adsorption instruction unit, the fixed voltage application unit causes the head to move to the adsorption position of the disk medium and stops a rotation of the disk medium to cause the head to be adsorbed onto the disk medium.

6. A disk controlling method, comprising:
detecting a failure of a disk apparatus; and
issuing an instruction to overwrite a storage area of the disk apparatus with a predetermined value responsive to said detecting.
